(19) United States
(12) Patent Application Publication
(10) Pub. No.: US 2018/0104030 A1
(43) Pub. Date: Apr. 19, 2018

(54) A METHOD FOR THE PRODUCTION OF A PROSTHETIC ARTICLE

(71) Applicant: Marco BARDELLI, Bucine (AR) (IT)

(72) Inventor: Marco BARDELLI, Bucine (AR) (IT)

(21) Appl. No.: 15/564,787

(22) PCT Filed: Apr. 6, 2016
(86) PCT No.: PCT/IB2016/000442

§ 371 Date: Oct. 6, 2017

(30) Foreign Application Priority Data
Apr. 7, 2015 (IT) AR2015A000008

(51) Int. Cl. A61C 13/00; A61C 8/00; A61C 13/34

(52) U.S. Cl. CPC A61C 13/0006; A61C 8/0027; A61C 13/34; A61C 13/0027; A61C 8/0048

(57) ABSTRACT

Method for the production of a prosthetic article including mounting at least two implants supporting the prosthetic article to be realized, in a model reproducing the user's gum, with the implants along the profile, heating a first implant to fuse an end of a first metallic wire to a first abutment corresponding to the portion emerging from the model of the first implant, heating the wire at a temperature lower than its melting temperature, in order to stretch it between the abutments, so that its development line is substantially parallel to the profile of the model at each point, heating the second implant in order to allow the fusion of the other end the first wire on the second abutment, so as to form a first bridge, and shaping with the technical material the first and the second abutment to form the artificial teeth of the prosthetic article.

### TECHNICAL FIELD

The present invention relates to a method for the production a prosthetic article.

### BACKGROUND ART

The prosthetic articles may be, for example, fixed dentures, when prosthetic articles are permanently cemented or screwed on natural and/or artificial teeth, or removable dentures (false teeth).

An endo-osseous implant which is normally used for the production of a prosthetic article includes a portion emerging from the gum, named abutment, being the support of the superior structure that replicates the natural tooth with the article, for example the crown of a single element, and a part that can be coupled to a screw associated to the gum.

The abutment-screw fixation, in bi-component systems, is realized by cementing or by screwing with a suitable fastening screw, also called retention screw.

On the other hand, there is a category of reduced-diameter implants (mini-implants), normally less than 3 mm, wherein the abutment is an integral part of the endo-osseous screw.

At the state of the art, in order to make a fixed or removable dental prosthesis, the investment casting of a metal, which is usually a dentistry alloy (gold, palladium-chromium and/or cobalt-based) is performed in order to form abutments of the implants that will be subsequently covered with resins and technical material moulded to obtain the artificial teeth.

This technique, although reliable and well-established, requires a long time (from four to six hours of continuous work) with high labour costs.

Furthermore, due to the fusion, twists and micro-porosity can form on the prosthetic article.

Also known is a faster process, therefore less expensive than the above-described known art, which involves the construction of a main model, also called “master” model, normally in refractory material, on which the screw-shaped portions of the implants are implanted and fixed by means of self-curing resins.

The implants are then detached from the base of the “master” model to avoid damaging the same model with the following operations. In fact, the emerging part of such implants is covered with an appropriate technical material, such as for example composite and light-curing material and polymers, including artificial teeth, which is appropriately shaped to obtain the artificial teeth of the prosthesis, thus rigidly associated to each other by welding of the metal bars at the emerging part of the same implants, making the implant-bar structure exceptionally solid and unchangeable.

Once the last finishing operation is completed, the implants are again mounted on the “master” model and the abutments and the bridge are filled with a cosmetic filler, so as to shape the artificial teeth, and welded between them.

The problem arising in this production method is linked to the risk of positioning errors that occur when the implant is removed from the “master” model and then re-assembled on the same after heavy mechanical machining, often giving rise to serious inaccuracies, with remarkable consequences from the medical and/or economic point of view.

To prove that, after final repositioning of the abutments on the “master” model, the operator always performs a control to verify the positioning accuracy.

### DISCLOSURE OF THE INVENTION

The aim of the invention is to eliminate the above-described drawbacks in known types of methods for the production of a prosthetic article that is more convenient compared to the known art in terms of time and cost.

Within the above aim, an object of the present invention is to provide a method for the production of a prosthetic article, which is able to overcome the problems related to execution precision, so as not to cause problems during assembly of the implant in the patient's mouth.

Another object of the present invention is to obtain a resistant prosthesis having excellent aesthetic features.

Another object of the invention is to provide a method for the production of a prosthetic article, by using readily commercially available means and commonly used materials, so that the method is even more economically competitive.

This aim, these objects and other objects, which will become more apparent hereinafter, are achieved by a method for the production of a prosthetic article according to the invention, characterized in that it comprises the steps consisting in:
assembling at least two support implants on the prosthetic article to be realized, in a model reproducing the user's gum, said implants being in succession to one another along the profile of the model,
heating a first implant in order to allow the fusion of an end of a first wire to a first abutment corresponding to the portion emerging from the model of said first implant, said first wire being to be stretched between said first abutment and at least one second abutment corresponding to the portion emerging from the model of at least a second implant 3 placed in succession to said first implant,
heating said first wire at a temperature lower than its melting temperature, so as to stretch it between said first abutment and said at least one second abutment, in such a way that its line of development is substantially parallel to the profile of the model in each point,
heating said at least one second implant so as to allow the fusion of the other end of said first wire to said at least one second abutment, so as to form a first bridge,
modelling with technical material said first abutment and said at least one second abutment to form the artificial teeth of the prosthetic article.

### BRIEF DESCRIPTION OF THE DRAWINGS

Further features and advantages of the invention will be more apparent from the description of a preferred but not exclusive embodiment of the method for the realization of a prosthetic article, illustrated by way of non-limiting example with the aid of the accompanying drawings, wherein:

FIG. 1 is an elevational view of a prosthetic article, made with a first variant of the process according to the invention, in which two implants 2 and 3 are connected by a metallic wire 6;

FIG. 2 illustrates a prosthetic article in close-up view, made with another variant of the process according to the invention, in which two implants 2 and 3 are connected by a bundle of metallic wires 16 consisting of four wires 6, 6′, 6″ and 6′″;

FIG. 3 represents an elevational view of the prosthetic article of FIG. 1, elevation, in which the bundle of metallic wires 16 is melted to form a bar 26;

FIG. 4 is a prosthetic article in elevational view, realized with a further variant of the process according to the invention, in which four implants 2, 3, 4 and 5 are connected two by two by means of a first metallic wire 6, a second metallic wire 7 and a third metallic wire 8;

FIG. 5 illustrates another prosthetic article in elevational view, realized with a different variant of the process according to the invention, in which four implants 102, 103, 104 and 105 are connected by a bundle of metallic wires 116 made of four wires 106, 106′, 106″ and 106′″;

FIG. 6 represents the prosthetic article of FIG. 5, in elevational view, wherein the wire bundle 116 is melted to form a bar 126.

### MODES OF CARRYING OUT THE INVENTION

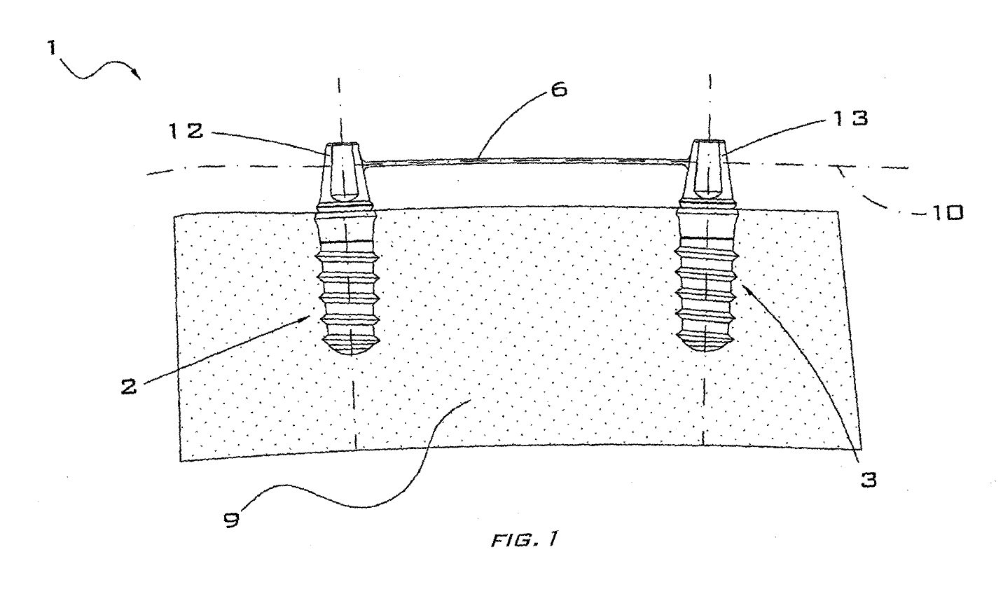

With reference to FIGS. 1, 2, 3 and 4, a fundamental feature of the method for the production of a prosthetic article according to the invention, which is identified as a whole with reference numeral 1, is the fact of comprising the steps consisting in:
mounting at least two implants 2 and 3, a first implant 2 and a second implant 3, both supporting the prosthetic article to be realized, in a model 9 reproducing the user's gum, with the implants 2 and 3 placed in succession between them along the profile 10 of model 9;
heating the first plant 2 so as to allow the melting of an end of a first metallic wire 6 at a first abutment 12 corresponding to the portion emerging from the model 9 of implant 2. The wire 6 must be subtended between the two abutments 12 and 13. For its part, the abutment 13 corresponds to the portion, emerging from model 9, of a second implant 3 placed in succession to the first implant 2,
heating the first metallic wire 6 to a lower temperature compared to its melting temperature, so as to stretch it between the two abutments 12 and 13, so that its line of development is substantially parallel to profile 10 of model 9 in each point,
heating the second implant 3 so as to allow the melting of the other end of the metallic wire 6 at the second abutment 13, so as to form a first bridge,
finish the abutments 12 and 13 with finishing means,
filling with a cosmetic filler abutments 12 and 13 and bridge 6, so that, modelling the first abutment 12 and the second abutment 13, both emerging from model 9, with technical material, artificial teeth of the prosthetic article 1 are formed.

For processing with finishing means, such as rotary instruments (micro-motor) and/or with metal cutters, the soldered article (implants 2 and 3 and wire 6) can be removed from model 9 then replaced to be modelled with the cosmetic filler.

The fusion between the ends of the wire 6 and the abutments 12 and 13 takes place by soft soldering, namely melting at less than 450° C., wherein the molten metal binds by capillarity with the heated abutment (methodi-cal soft soldering).

Technical material, known per se, is related to composite and light-curing material and polymers, including artificial teeth.

Advantageously, the material used for the model 9 is plaster, suitable for soldering operations that are prepared for the realization of the model by the process according to the invention.

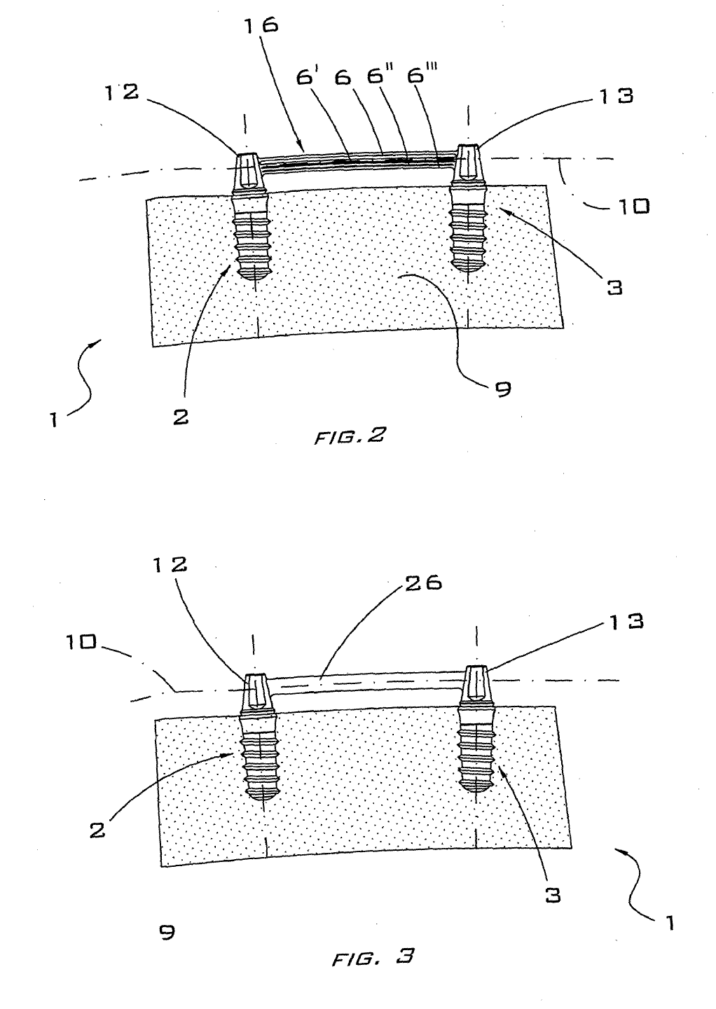

Advantageously, a set of metallic wires 6, 6′, 6″, 6″ can be subtended between the first and the second abutment 13, one after another, to form a wire bundle 16 (FIG. 2).

This means that, in the case where there is the need to add other metallic wires, for example if the wires forming the bundle are four (6, 6′, 6″, 6′″), as illustrated in FIG. 2, similarly as described, after mounting the implants 2 and 3 in the model 9 and making the first bridge of the wire 6 and the second bridge of the wire 6, the subsequent bridges will follow, in this case the third for wire 6″ and the fourth for wire 6′″.

The third bridge will be obtained by welding one end of the wire 6″ to the heated first abutment 12, straining the same wire 6″ between abutments 12 and 13 following the profile 10 and then welding the other end of the wire 6″ to the heated second abutment 13.

The fourth bridge, as usual, will be obtained by welding one end of the wire 6″ to the heated first abutment 12, straining the same thread 6″ between abutments 12 and 13 following the profile 10 and then welding the other end of the wire 6″ to the heated second abutment 13.

With four bridges made, it will be sufficient to melt together wires 6, 6′, 6″ and 6′″ with one another in order to form bar 26, having a predetermined diameter section (FIG. 3).

Practically, a set of metallic wires 6, 6′, 6″ and 6′″ are subtended, each interposed between two abutments 12 and 13 emerging from the respective implants 2 and 3 supporting the prosthetic article 1 and positioned in succession with respect to one another along the profile of the model 9.

Preferably, the metallic wires 6, 6′, 6″ and 6′″ of the bundle 16 are melted, and then heated to the melting temperature, to form a bar 26 having a predetermined diameter section (FIG. 3).

Advantageously, the sum of the diameters of the metallic wires 6, 6′, 6″ and 6′″ constituting the bundle 16 is substantially equal to the predetermined diameter of the bar 26 obtained from the fusion of the metallic wires 6, 6′, 6″ and 6′″.

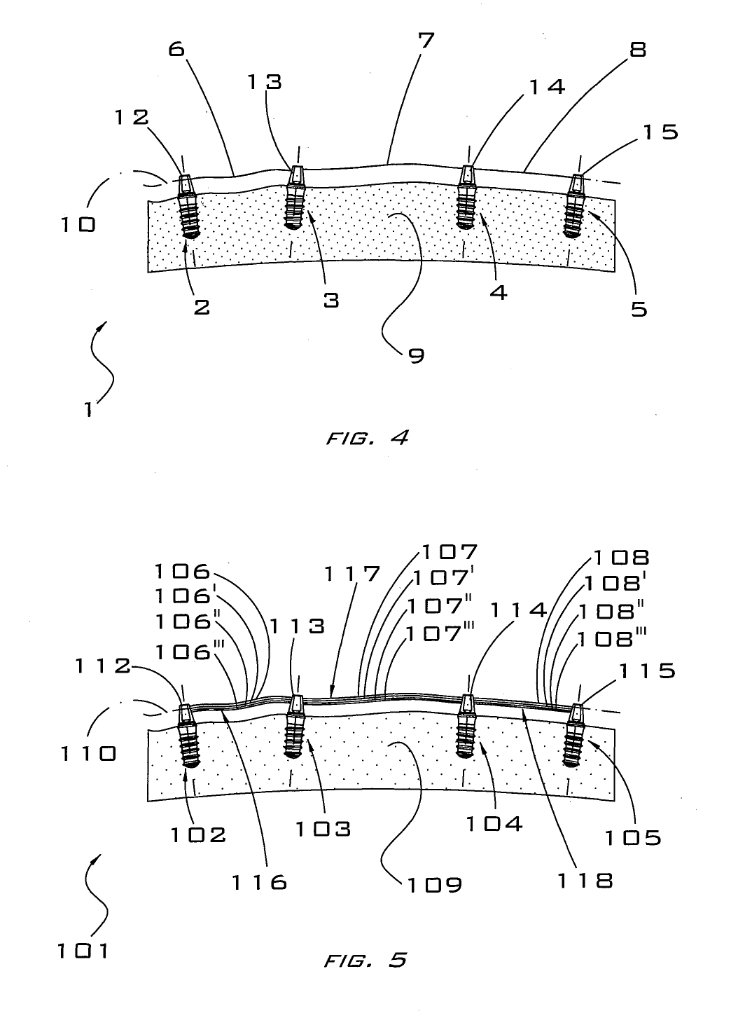

Preferably, the metallic wires 6, 6′, 6″ and/or 6′″ are of a dental alloy. If the prosthetic support 1 is supported by more implants 2, 3, 4 and 5, in series with each other, as shown in FIG. 4, these steps will have to be repeated to allow to subtend a second wire 7 between the abutments 13 and 14 and a third wire 8 between the abutments 14 and 15. The abutments 12, 13, 14 and 15 are each emerging from the respective implants 2, 3, 4 and 5.

With reference to FIG. 4, the procedure in question therefore involves, once implants 2, 3, 4 and 5 are mounted, heating them to melt one end of the wire 6 to the abutment 12, stretching the wire 6 between the abutment 12 and the associated abutment 13. Equally, the second wire is pinned to the abutment 13, at the other side of the abutment relative to the wire 6 and subtended in a similar manner between the abutments 13 and 14. Similarly, the wire 8 will be subtended between the abutments 14 and 15. To subtend the wires 6, 7 and 8, they must be heated below the melting point so as to shape the bridgings so that their development line is substantially parallel to the profile 9 of the model at each point.

The soldered article (complete with implants 2, 3, 4 and 5 and wires 6, 7 and 8) is finished with finishing means (rotary instruments and/or metal cutters).

For this operation, it can be removed from the model 9 and then repositioned for modelling with the cosmetic filler.

At this point, it will be possible to model the technical material with the abutments 12, 13, 14 and 15 and such bridges without removing the implants 2, 3, 4 and 5 from the model 9 so that they can be processed with the cosmetic filler and thus form the artificial teeth of the prosthetic article 1 (FIG. 4).

Obviously, by changing the number “n” of implants of the set, it will be necessary to subtend a number of wires “n−1” each between a pair of abutments in succession.

The process just described can be applied to articles having any number of implants; however, changing the number of implants (and thus of abutments) the inventive concept remains unchanged having to do, in fact, with a technically equivalent procedure to that described to this point.

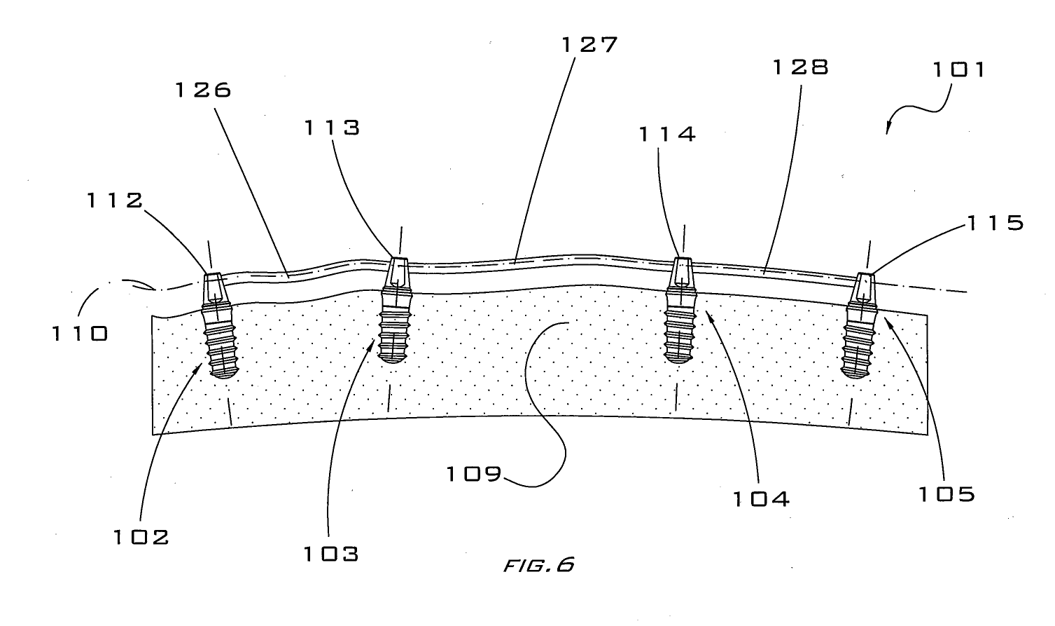

In another embodiment, shown in FIGS. 5 and 6, the method for the production of a prosthetic article 101 has the fundamental feature that it comprises the steps consisting in:
mounting a set of implants 102, 103, 104 and 105 to support the prosthetic article to be made, in a model 109 reproducing the user's gum,
heating a first implant 101 so as to allow the melting of an end of a first metallic wire 106 at a first abutment 112 corresponding to the portion emerging from the model 109 of the first implant 102. The first wire 106 is to be stretched between the two abutments 112 and 113, the latter corresponding to the portion of at least a second implant 103 emerging from the model 109, with the second implant 103 placed in succession to the first implant 102 along the profile of model 109,
heating the first metallic wire 106 at a temperature lower than its melting temperature so as to stretch it between the first and the second abutment 112 and 113, so that its development line is substantially parallel to the profile 110 of the model 109 at each point,
heating the second implant 103 so as to allow the melting of the other end of the metallic wire 106 at the second abutment 113, so as to form a first bridge,
welding one end of at least one other metallic wire 106′, 106″ and 106′″ to said heated first abutment 112,
stretching the other metallic wire 106′, 106″ and 106′″ between the abutments 112 and 113, to obtain at least one second bridge and in such a way as to form a first wire bundle 116,
welding the other end of the wire 106′, 106″, 106′″ to the second heated abutment 113,
melting together wires 106, 106′, 106″ and 106′″ of the bundle 116 to form a first bar 126.

Even in this case, the model 109 is advantageously made of plaster, a material which, as mentioned, is suitable for the machining (soldering) necessary to the implementation of the model by means of the method according to the invention.

Advantageously, stretching at least another set of metallic wires 107, 107′, 107″ and 107′″ is involved, so as to form at least a second wire bundle 117, and then melting together such metallic wires 107, 107′, 107″, 107′″ of the second bundle 117 to form a second bar 126.

Preferably, the steps involving stretching of a set of metallic wires 106, 106′, 106″, 106′″, 107, 107′, 107″, 107′″ 108, 108′, 108″ and 108′″ are to be repeated in order to form metallic wire bundles 116, 117 and 118 (FIG. 5). Each of these bundles 116, 117 and 118 is thus interposed between two subsequent abutments 112 and 113, 113 and 114, 114 and 115, where the abutments 112, 113, 114 and 115 emerge from the respective implants 102, 103, 104, 105 supporting the prosthetic article 101 and are positioned in succession to one another along the profile of the model 109. Even in this case, metallic wires 106, 106′, 106″, 106′″, 107, 107′, 107″, 107′″ 108, 108′, 108″ and 108′″ of bundles 116, 117 and 118 will be melt to form a set of bars 126, 127 and 128 for connection between two successive implants 102 and 103, 103 and 104, 104 and 105 (FIG. 6).

Advantageously, each of the bars 126, 127 and 128 has a section of predetermined diameter.

Once the structure formed by implants 102, 103, 104 and 105 and bars 126, 127 and 128 is realized, it will be possible to model the abutments 112, 113, 114 and 115 and the bars 126, 127 and 128 emerging from the model 109 with technical material, so that they can be machined with the cosmetic filler to form the artificial teeth of prosthetic article 101.

The procedure in question therefore involves that, once implants 102, 103, 104 and 105 have been mounted, they are heated to melt the first ends of each of the metallic wires 106, 106′, 106″ and 106′″ to the abutment 112 and the second ends of these wires to the abutment 113 so that the wire bundle 116 is subtended between these two abutments 112 and 113. Similarly, the second set of wires 107, 107′, 107″, 107′″ will be subtended between the abutments 113 and 114. Similarly, the third set of wires 108, 108′, 108″, 108′″ will be subtended between the abutments 114 and 115. To subtend the wires 106, 106′, 106″, 106′″, 107, 107′, 107″, 107′″ 108, 108′, 108″ and 108′″, they must be heated below the melting point in order to shape the bridges, so that their development line is substantially parallel to the profile of the model 109 at each point.

After forming the bridges and the bars 126, 127 and 128, the soldered article, namely the implants 102, 103, 104 and 105 with the respective abutments 112, 113, 114 and 115, as well as the bars 126, 127 and 128, is finished by using finishing means, for example rotary instruments and/or metal cutters.

Next, it is possible to model the abutments 112, 113, 114 and 115 with technical equipment without removing them from the model 109 and thus forming the artificial teeth of prosthetic article 101.

Preferably, for the finishing, the soldered article can be removed from the model 109 and then repositioned on it for modelling with the cosmetic filler.

The process just described can be applied to articles having any number of implants; however, changing the number of implants (and thus of abutments) the inventive concept remains unchanged having to do, in fact, with a technically equivalent procedure to that described to this point.

From the above description, it is thus evident that the invention achieves the proposed aim and objectives and, in particular, it is highlighted that a method is provided for making a prosthetic article, which is more convenient, in terms of time and costs, compared to the known art.

For example, the working time of four or five hours required by the known art for a prosthesis is reduced to less than ten minutes.

In particular, the realization of the entire structure in the usual and only model, therefore without assembling and disassembling the implant from a “master” model to other models, guarantees absolute precision, hence with no issues during the implant procedure in the patient's mouth.

Another advantage of the manufacturing method according to the invention is given by the fact that, since investment casting is avoided, the risk of twists and material micro-porosity are prevented.

Another advantage of the invention is the fact that, by choosing a suitable number of metallic wires (and then a corresponding number of bridges) to make the bundle of metallic wires which form the bar allows the dental technician to fabricate highly resistant implants.

Furthermore, another advantage of the invention is given by the fact that, since the finishing is done on the model and not within the oral cavity, as for example happens with laser welding, surpluses of composites or resins are avoided, ensuring superior hygienic conditions.

Not least, the use of readily commercially available means and common materials makes the method economically competitive.

The so-designed invention is susceptible of numerous modifications and variations, all of which fall within the scope of the inventive concept.

Obviously, by changing the number of wires and/or the number of abutments (and therefore of installations), the inventive concept remains unchanged, having to do, in fact, with a technically equivalent procedure to that described hitherto.

Furthermore, all the details may be replaced by other technically equivalent features.

In practice, the materials employed, as well as the dimensions, may be different according to necessities, provided that they are consistent with the realization purpose.

1. A method for the production of a prosthetic device (1), comprising:
mounting at least two implants (2, 3) for supporting the prosthetic device to be realized, in a mold (9) reproducing the gums of the user, said implants (2, 3) being in succession to one another along the profile (10) of the mold (9),
heating a first implant (2) so as to allow the merging of one end of a first metal wire (6) to a first stump (12) corresponding to the portion emerging from the mold (9) of said first implant (2), said first wire (6) being stretched between said first stump (12) and at least a second stump (13) corresponding to the portion emerging from the mold (9) of at least a second implant (3) placed in succession to said first implant (2),
heating said first metal wire (6) to a temperature lower than its melting temperature, so as to stretch it between said first stump (12) and said at least one second stump (13), in such a way that its line of development is substantially parallel to the profile (10) of the mold (9) at each point,
heating said at least a second implant (3) so as to allow the fusion of the other end of said first wire (6) to said at least second stump (13), so as to form a first truss,
finishing with aesthetic finishing means said first stump (12) and said at least one second stump (3),
shaping with technical material said first stump (12), said at least one second stump (13) and said first truss to form the artificial teeth of the prosthetic device (1).

2. The method according to claim 1, further comprising subtending, between said first stump (12) and said at least one second stump (13), a series of metal wires (6, 6′, 6″, 6′″), one after another, to form a bundle of metal wires (16).

3. The method according to claim 2, further comprising melting said metal wires (6, 6′, 6″, 6′″) of the bundle (16) to form a bar (26) having a section of predetermined diameter.

4. The method according to claim 3, wherein the sum of the diameters of the metal wires (6, 6′, 6″, 6′″) constituting the bundle (16) is substantially equal to the predetermined diameter of the bar (26) obtained from the fusion of said metal wires (6, 6′, 6″, 6′″).

5. A method for the production of a prosthetic device (101), further comprising the steps that consist in:
mounting a series of implants (102, 103, 104, 105) for supporting the prosthetic device to be realized, in a mold (109) reproducing the gums of the user, said implants (102, 103, 104, 105) being positioned along the profile (110) of the mold (109),
heating a first implant (101) so as to allow the merging of one end of a first metallic wire (106) to the first stump (112), corresponding to the portion emerging from the mold (109) of said first implant (102), said first wire (106) being to be stretched between said first stump (112) and at least a second stump (113), corresponding to the portion of at least a second implant (103) emerging from the mold (109), said at least a second implant (103) being positioned in succession to said first implant (102) along the profile of the mold (109),
heating said first metal wire (106) to a temperature lower than its melting temperature so as to stretch it between said first stump (112) and said at least one second stump (113) in such a way that its line of development is substantially parallel to the profile (110) of the mold (109) at each point,
heating said at least one said second implant (103) so as to allow the fusion of the other end of said first wire (106) to said at least one second stump (113), so as to form a first truss,
welding an end of at least one other metal wire (106′, 106″, 106′″) to said first heated stump (112),
stretching said at least one another metal wire (106′, 106″, 106′″) between said first stump (112) and said at least one second stump (113) to obtain at least a second truss and in such a way as to form a first bundle of metal wires (116),
soldering the other end of said at least another metal wire (106′, 106″, 106′″) to said at least one second heated stump (113),
jointly melting said first metal wire (106) and said at least one another metal wire (106′, 106″, 106′″) of the first bundle (116) to form a first bar (126).

6. The method according to claim 5, further comprising tending at least one another series of metal wires (107, 107′, 107″, 107′″), in such a way as to form at least a second bundle of wires (117) and to merge the metal wires (107, 107′, 107″, 107′″) of the second bundle (117) together, in order to form a second bar (126).

7. The method according to claim 5, further comprising by repeating steps which include the fact of tending a series of metal wires (106, 106′, 106″, 106′″, 107, 107′, 107″, 107′″, 108, 108′, 108″, 108′″), so as to form bundles of metal wires (116, 117, 118) each interposed between two successive stumps (112 and 113, 113 and 114, 114 and 115), said stumps (112, 113, 114, 115) emerging from the respective implants (102, 103, 104, 105) for the support of the prosthetic device (101) and positioned in succession to one another along the profile of the mold (109), and to fuse together the metal wires (106, 106′, 106″, 106′″, 107, 107′, 107″, 107′″, 108, 108′, 108″, 108′″) into bundles (116, 117, 118) to form a series of bars (126, 127, 128) of connection between two successive implants (102 and 103, 103 and 104, 104 and 105).

8. The method according to claim 7, further comprising removing the braised device comprising said implants (102, 103, 104, 105) with its stumps (112, 113, 114, 115) and said bars (126, 127, 128) from said mold (109) to finish it by finishing means.

9. The method according to claim 8, further comprising refitting said braised device in said mold (109) to shape with technical material said stumps (112, 113, 114) emerging from the mold (109) and said bars (126, 127, 128), so as to form the artificial teeth of the prosthetic device (101).

10. The method according to claim 5, wherein each of said bars (126, 127, 128) has a section of predetermined diameter.

11. The method according to claim 6, further comprising by repeating steps which include the fact of tending a series of metal wires (106, 106′, 106″, 106′″, 107, 107′, 107″, 107′″, 108, 108′, 108″, 108′″), so as to form bundles of metal wires (116, 117, 118) each interposed between two successive stumps (112 and 113, 113 and 114, 114 and 115), said stumps (112, 113, 114, 115) emerging from the respective implants (102, 103, 104, 105) for the support of the prosthetic device (101) and positioned in succession to one another along the profile of the mold (109), and to fuse together the metal wires (106, 106′, 106″, 106′″, 107, 107′, 107″, 107′″, 108, 108′, 108″, 108′″) into bundles (116, 117, 118) to form a series of bars (126, 127, 128) of connection between two successive implants (102 and 103, 103 and 104, 104 and 105).

12. The method according to claim 6, wherein each of said bars (126, 127, 128) has a section of predetermined diameter.

13. The method according to claim 7, wherein each of said bars (126, 127, 128) has a section of predetermined diameter.

14. The method according to claim 8, wherein each of said bars (126, 127, 128) has a section of predetermined diameter.

15. The method according to claim 9, wherein each of said bars (126, 127, 128) has a section of predetermined diameter.

16. The method according to claim 11, wherein each of said bars (126, 127, 128) has a section of predetermined diameter.
